(19) United States
(12) Patent Application Publication
(10) Pub. No.: US 2017/0071283 A1
(43) Pub. Date: Mar. 16, 2017

(54) Massage shoe

(71) Applicant: Andrew Lee James, Orlando, FL (US)

(72) Inventor: Andrew Lee James, Orlando, FL (US)

(21) Appl. No.: 14/811,574

(22) Filed: Sep. 11, 2015

(51) Int. Cl. A43B 7/00; A61H 23/02; A43B 3/00

(52) U.S. Cl. CPC A43B 7/00; A43B 3/0005; A61H 23/02; A61H 2205/12; A61H 2209/00

(57) ABSTRACT

A massaging shoe; switchable on and off, powered by battery or other power supply and using various possible means to provide massaging including; vibration, roller balls, bearing balls and various other methods. One example would include a hard bottom core or sole made of rubber or other material in order to allow motors to be securely attached; then a gel layer that will encase the various different massaging units; there will then be an additional layer above that comprising of a ‘comfortable to the user’ fabric or other material, which will allow movement from below to affect the wearer's feet.

The example item is comprised of various different units to induce massage or vibration, a motor for each necessary vibratory or massaging unit, a battery and switch and wiring to provide said power to said massaging or vibratory units and recharging capabilities. Our patent is meant to cover all available massaging means. However, we have included several suggested ways of providing the different, various methods we have already explored. However, those are just for illustration purposes only and our patent is geared towards simply a massaging shoe.

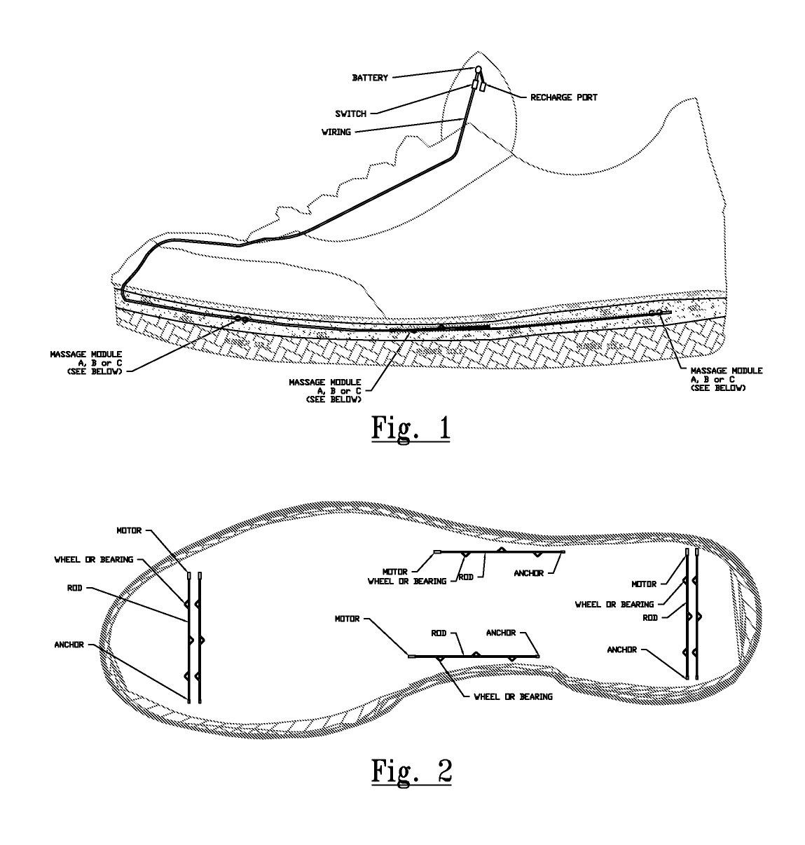

As shown in FIG. 1 the wearer would be able to turn on and off the massaging units, recharge the battery at his or her pleasure or convenience. The units massaging units in FIG. 1 are rotating rods powered by a motor. It is suggested that the user/wearer of the shoe sit down before turning on massaging units for maximum effect.

As shown in FIG. 2 the massage units are placed strategically to maximize the massaging effect to the wearer's foot.

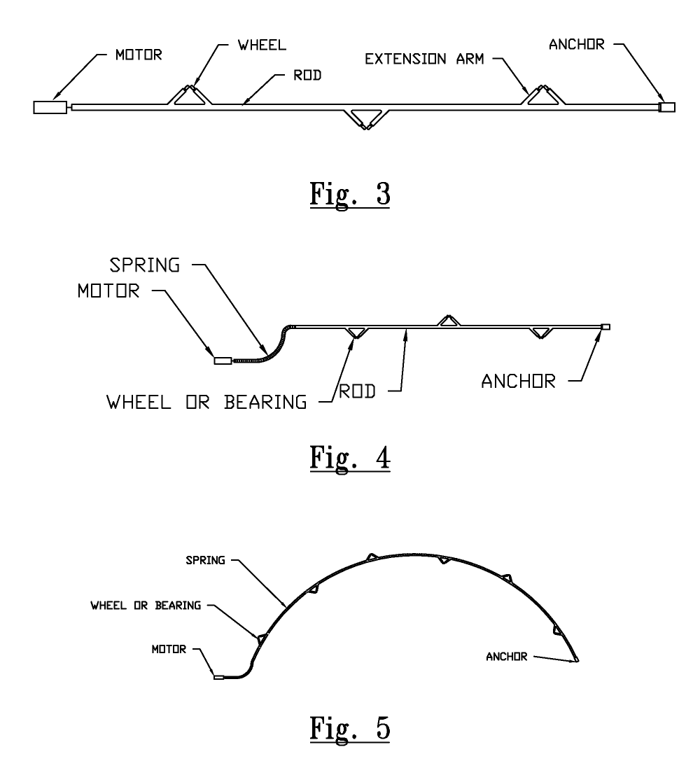

As shown in FIG. 3 the unit can be easily manufactured and easily placed strategically in the shoe with the accompanying motor to provide rotation of said rod assembly to facilitate massaging of the foot.

As shown in FIG. 4, 5 the varying uses of materials like springs allowing for placement inside the shoe has to maximize massaging to the user's front.

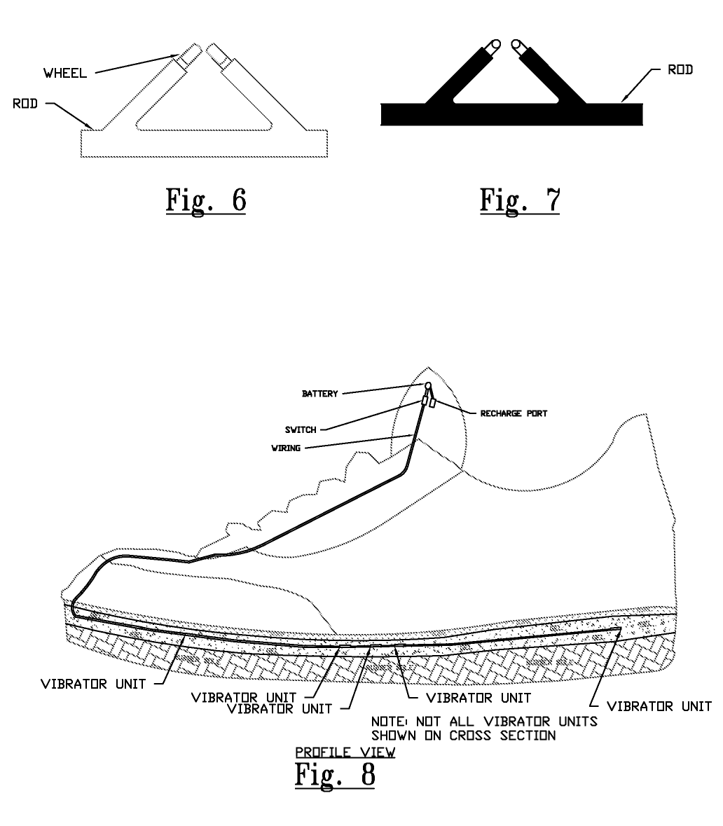

As shown in FIGS. 6 through 8 the different materials and configurations are shown for better clarification I was suggested materials in placement.

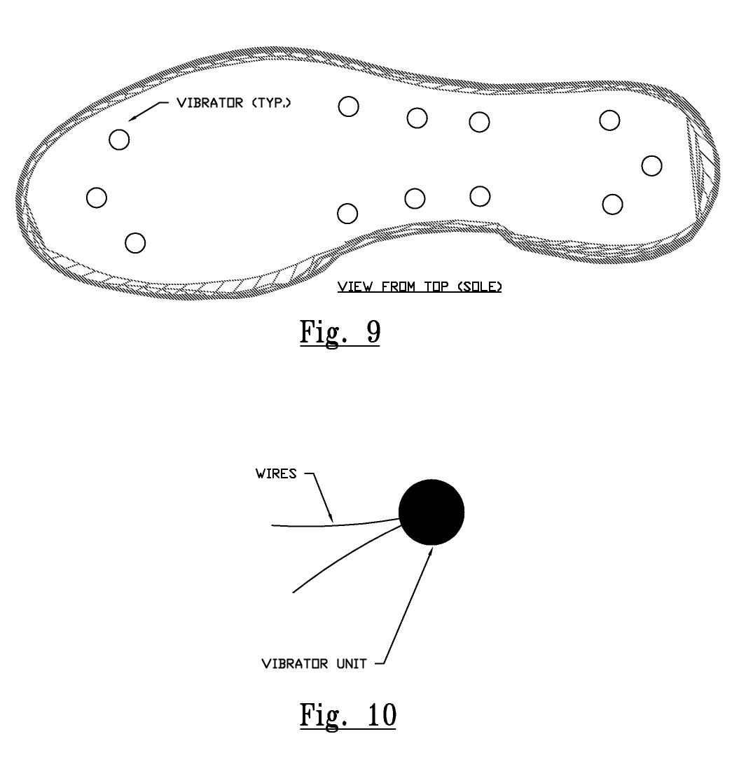

As shown in FIGS. 9+10 use of commonly available vibrating units along with power supply, switches, recharge ability would easily allow so user to enjoy a comfortable relaxing vibration in order to reenergize the user's foot.

The use of massaging and or vibrating of a user's foot increases blood flow and stimulates the nerves I of a user's foot in a pleasant manner. Increasing blood flow helps rejuvenate the users feet and helps patients with debilitating foot problems such as diabetes.

1. I claim that people that walk longer, run farther and people with debilitating feet problems such as diabetes will be assisted if a shoe is outfitted with these massaging device/unit(s).

2. I claim that people that have shoes that provide massage therapy or vibrate feet will have a better emotional state, physical state, mental state and will likely be more inclined be kind to other people, work harder, be more successful, heal faster and have a better quality of life. Creation of massaging shoe or vibratory shoe is helpful to society, profitable to the manufacturer and easy to make.

3. (canceled)

4. The on demand nature of the device allows the user to select the appropriate time to use the needed massaging as their doctor recommends or as needed.
